(19) United States
(12) Patent Application Publication
(10) Pub. No.: US 2008/0228663 A1
(43) Pub. Date: Sep. 18, 2008

(54) Systems For Leveraging Capital And Associated Methods

(76) Inventor: Scott Smith, Louisville, CO (US)

Correspondence Address: LATHROP & GAGE LC, 4845 PEARL EAST CIRCLE, SUITE 300, BOULDER, CO, 80301, US

(21) Appl. No.: 12/013,292

(22) Filed: Jan. 11, 2008

Related U.S. Application Data
(60) Provisional application No. 60/884,533, filed on Jan. 11, 2007.

(51) Int. Cl. G06Q 40/00

(52) U.S. Cl. 705/36 R

(57) ABSTRACT

A system, method and software product determines pool financing structure of a venture capital fund. Investment guidelines that specify initial investment parameters of companies that the venture capital fund intends to invest in and cash flow through the pool financing structure are input. Projected returns for equity investors and general partners of the venture capital fund are evaluated by modeling fund investments and cash flow through the pool financing structure over a range of economic conditions. The venture capital fund is modeled for rating agencies to determine levels of subordination, within the pool financing structure, necessary to achieve investment guide ratings. Optimal pool financing structure of the venture capital fund and optimal investment parameters of the companies based upon the economic conditions and the investment guide ratings are determined to maximize returns for the equity investors and general partners.

### RELATED APPLICATIONS

This application claims priority to U.S. Provisional Application Ser. No. 60/884,533, filed Jan. 11, 2007, and incorporated herein by reference.

### BACKGROUND

Venture capital is a high-risk, high-return endeavor that entails investing capital in support of business creation and growth. In pursuit of high returns, a venture capital (“VC”) firm raises funds typically between $100 million and $3 billion.

The VC firm's funds are typically organized as limited partnerships, limited liability companies or limited liability partnerships. Investors who invest money into the funds are generally known as limited partners (LPs). The VC firm may have one or more general partners (GPs), also known as venture capitalists, who invest the fund's money to develop companies. For a typical VC fund, LPs contribute the majority, if not all, of the committed capital while GPs contribute little, if any of the committed capital. As returns are made on the fund's investments, the LP's invested principal and fund profits are typically distributed back to the partners in the same percentages as originally invested, although sometimes LPs will receive a return on their money before GPs.

FIG. 1 shows an exemplary prior art venture fund 100 that has 99% equity 102 contributed by LPs and 1% equity 104 contributed by GPs. Fund 100 is shown making a yearly return 106. Return 106, for example, represents net return after management costs and other monetary consideration have been deducted. FIG. 2 illustrates an example where LP equity 102 of FIG. 1 is formed of four LP equity shares 202, 204, 206 and 208, representing 40%, 20%, 20% and 20%, respectively. Accordingly, it is known that LPs need not contribute the same amount of capital to fund 100.

VC firms receive compensation for their investment and management activities in two ways. First, they may receive an annual management fee paid by the fund to a management corporation which employs the venture capitalists and their support staff. The annual management fee usually approximates 2.5% of committed capital; however, it is often lower at the very beginning and end of the fund when investment activity is low. Second, the VC firm receives compensation through the allocation of net income from the fund. The fund's primary source of net income is capital gains from the sale or distribution of stock of the companies in which it invests. The GPs typically receive 20% of net capital gains while the LPs receive 80%, although this proportion may vary from fund to fund depending upon the GP's prior investment record and present market conditions.

A typical VC fund passes through four stages of development that last for a total of about ten years. The first stage is fundraising. It takes the GPs of the fund (e.g., venture fund 100) six months to a year, for example, to obtain capital commitments from its LPs. LPs include state and corporate pensions funds, public and private endowments and private investors.

The second stage lasts between about three to six years and includes sourcing, due diligence and investment. Sourcing means that a company for potential investment has been brought to the attention of the firm. Sourcing occurs through reading trade press, attending trade conferences and speaking to those with industry familiarity, and by companies contacting the VC firm. A junior member, a.k.a. an Associate or Analyst, spends the majority of his/her time sourcing companies. After a GP or junior member sources a prospective deal, extensive research is done on the company and its market. Occasionally this process, called due diligence, leads to an investment. Companies in which VC firms invest become “portfolio companies.”

The third stage, which lasts until the fund's closing, operates to help portfolio companies grow. The portfolio company and the VC firm unite to form a team whose goal is to increase the value of the portfolio company. The VC firm becomes an equity participant in the portfolio company through a deal structure typically including stock, warrants, options and convertible securities. In return, the VC firm provides financing and a representative who sits on the portfolio company's board. As a board member, the VC representative offers strategic advice to the management team and assures that his/her firm's interests are considered.

The fourth and final stage in the life of a venture fund is its closing. By the expiration date of the fund, the VC firm should have liquidated its position in all of its portfolio companies. Liquidation of each portfolio company usually occurs in one of three ways: an Initial Public Offering (IPO), the sale of the company to a third party or Chapter 11. Typically an IPO realizes the greatest return on investment.

Equity funds in general, and in particular venture capital funds, have historically raised capital through limited partnerships in which the limited partners have equal status with each other in regard to sharing returns from the fund proportional to their investment. For example, under the usual current conventional limited partnership structure, returns 106 from fund 100 are distributed pro rata based upon the amount that each LP invested; LPs are usually not given preference over other LPs as to how and when they will receive returns on their investment. That is, in FIG. 1, LP equity 102 receives 99% of return 106, of which equity share 202 receives 40%, equity share 204 receives 20%, equity share 206 receives 20% and equity share 208 receives 20%, as per FIG. 2. For example, assuming an equal distribution between LPs and GPs, if return 106 equated to a 20% return from fund 100, each LP receives a return of 20% of its contributed equity. In this example, if fund 100 represents equity of $1 billion, and net return 106 is $200 million, equity share 202 earns a return of $79,200,000, and each of equity shares 204, 206 and 208 receives a return of $39,700,000.

There has, however, been some variation of employed strategies regarding differentiating the allocation of returns between LPs and GPs. Such strategies have usually been designed to provide additional security to the LPs, and/or have been used as bonus mechanisms to reward the GPs for exceptional performance; but strategies have not been used to reduce the cost of capital for the VC fund, except for certain “funds of funds” in which the fund itself invests in partnership positions rather than investing its money directly in a portfolio of companies. Attempts have been made within the venture capital industry to reduce the cost of capital for equity and venture funds through credit enhancement; but such strategies have met with limited success. These attempts have entailed buying necessary credit enhancements by purchasing guarantees from institutional insurers for a portion, if not all, of the securities being sold, to finance the VC fund. While this methodology can work in theory, the cost of the credit enhancement is often greater than the reduction in the cost of capital resulting from the enhancement.

### SUMMARY

In an embodiment, a method determines pool financing structure of a venture capital fund. Investment guidelines that specify initial investment parameters of companies that the venture capital fund intends to invest in and cash flow through the pool financing structure are input. Projected returns for equity investors and general partners of the venture capital fund are evaluated by modeling fund investments and cash flow through the pool financing structure over a range of economic conditions. The venture capital fund is modeled for rating agencies to determine levels of subordination, within the pool financing structure, necessary to achieve investment guide ratings. Optimal pool financing structure of the venture capital fund and optimal investment parameters of the companies based upon the economic conditions and the investment guide ratings are determined to maximize returns for the equity investors and general partners.

In an embodiment, a method for determining pool financing structure of a venture capital fund includes inputting investment guidelines that specify initial investment parameters of companies that the venture capital fund intends to invest in and cash flow through the pool financing structure. Capital commitment information of investors in the venture capital fund is input, and projected returns for the investors evaluated, by modeling fund investments and cash flow through the pool financing structure over a range of economic conditions. The venture capital fund is modeled for the capital commitment, capital call and issue rated securities to determine optimal pool financing structure of the venture capital fund and optimal investment parameters of the companies based upon the economic conditions and the issue rated securities, to maximize returns for the investors.

In an embodiment, a software product has instructions, stored on computer-readable media, wherein the instructions, when executed by a computer, perform steps for determining parameters of a venture fund, including: instructions for inputting investment guidelines that specify initial investment parameters of companies that the venture capital fund intends to invest in and cash flow through the pool financing structure; instructions for evaluating projected returns for equity investors and general partners of the venture capital fund by modeling fund investments and cash flow through the pool financing structure over a range of economic conditions; instructions for modeling the venture capital fund for rating agencies to determine levels of subordination, within the pool financing structure, necessary to achieve investment guide ratings; and instructions for determining optimal pool financing structure of the venture capital fund and optimal investment parameters of the companies based upon the economic conditions and the investment guide ratings, to maximize returns for the equity investors and general partners.

In one embodiment, a software product comprising instructions stored on computer-readable media. When executed by a computer, the instructions perform steps for determining pool financing structure of a venture capital fund, including: instructions for inputting investment guidelines that specify initial investment parameters of companies that the venture capital fund intends to invest in and cash flow through the pool financing structure; instructions for inputting capital commitment information of investors in the venture capital fund; instructions for evaluating projected returns for the investors by modeling fund investments and cash flow through the pool financing structure over a range of economic conditions; and instructions for modeling the venture capital fund for capital commitment, capital call and issue rated securities to determine optimal pool financing structure of the venture capital fund and optimal investment parameters of the companies based upon the economic conditions and the issue rated securities, to maximize returns for the investors.

In an embodiment, a system leverages capital of a venture capital fund. The system includes memory for storing investment guidelines, fund goals, investment scenarios, and investment rating data. A simulator generates a model of a pool financing structure based upon the investment guidelines, fund goals, investment scenarios and investment rating data, and a processor executes the simulator to evaluate the performance of the pool financing structure and to determine optimal pool financing structure of the venture capital fund and optimal investment parameters of the companies, to maximize returns for the equity investors and general partners.

### BRIEF DESCRIPTION OF THE FIGURES

FIG. 1 shows an exemplary prior art venture fund that has 99% equity contributed by Limited Partners (LPs) and 1% equity contributed by General Partners (GPs).

FIG. 2 illustrates an example where LP equity of prior art FIG. 1 is formed of four LP equity shares representing 40%, 20%, 20%, and 20%.

FIG. 3 shows a system for leveraging capital, in an embodiment.

FIG. 4 shows one exemplary modeled fund that includes a first class of security that forms 40% of the equity of the fund and a remaining 60% equity that is formed from LP investment.

FIG. 5 shows one example of the first class of security of FIG. 4 being structured as a single bond of $400 million with an interest rate of 5%.

FIG. 6 shows one exemplary $1 billion fund that may be determined and modeled as a fund by the system of FIG. 3 where the fund has 40% of its equity funded by an interest-only bond of $400 million with a coupon value of 10%.

FIG. 7 is a flowchart illustrating one exemplary method for leveraging capital.

FIG. 8 shows the portion of principal intended to be invested in a portfolio that becomes defaulted and the portion set aside as reserve.

FIG. 9 shows the expected increase in a ratio of defaulted assets to principal invested between year one and year eight.

FIG. 10 shows a reserve portion of a fund broken into component parts.

FIG. 11 shows expected changes to a principal investment between year one, year two and year eight.

FIG. 12 shows one exemplary modeled fund that has a capital commitment of $1 B, with a first class of security forming a percentage of total fund equity.

FIG. 13 shows the first class of security of FIG. 12 being structured as a single bond of $300 million with an interest rate of 5%.

### DETAILED DESCRIPTION OF THE FIGURES

A structured finance system and methodology is now disclosed to improve processes for capitalizing equity pools, and more particularly for venture capital partnerships, by increasing returns for both limited partners (LPs) (i.e., investing partners) as well as general partners (GPs) (i.e., managing partners) when compared to conventional methodologies. The disclosed system and methodology also allows equity and venture funds to increase benefit from long-term cash-flow in their investment portfolio, rather than relying primarily upon gains from Initial Public Offerings (IPOs) and acquisitions as primary sources of return on investment (ROI). By increasing the effective return to a fund's equity class of investors, a smaller return from long-term cash-flow in the portfolio may be sufficiently leveraged to equal the necessary return for the fund's equity class of investor. This effectively broadens the range of acceptable “exit strategies” for the fund's portfolio and a wider range of business opportunities become acceptable for investment, allowing GPs (i.e., investment managers) to better diversify their portfolios and to return competitive yields to the LPs (i.e., their limited partners) under a wider range of economic conditions.

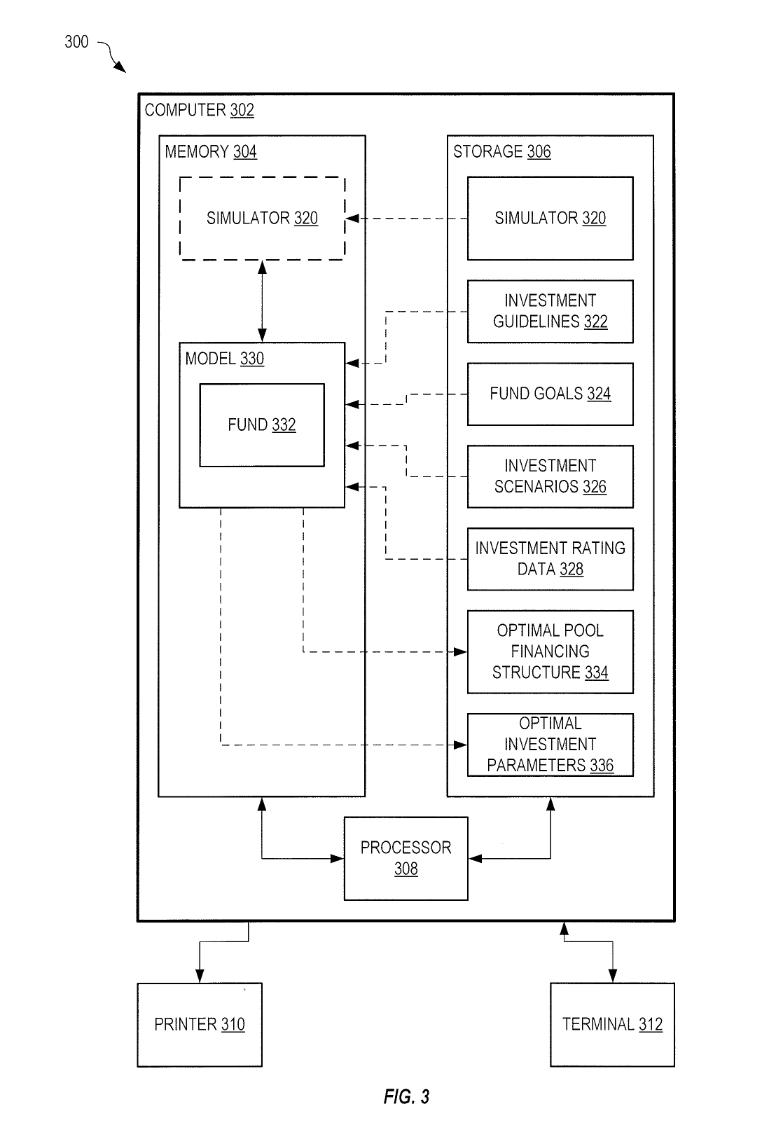

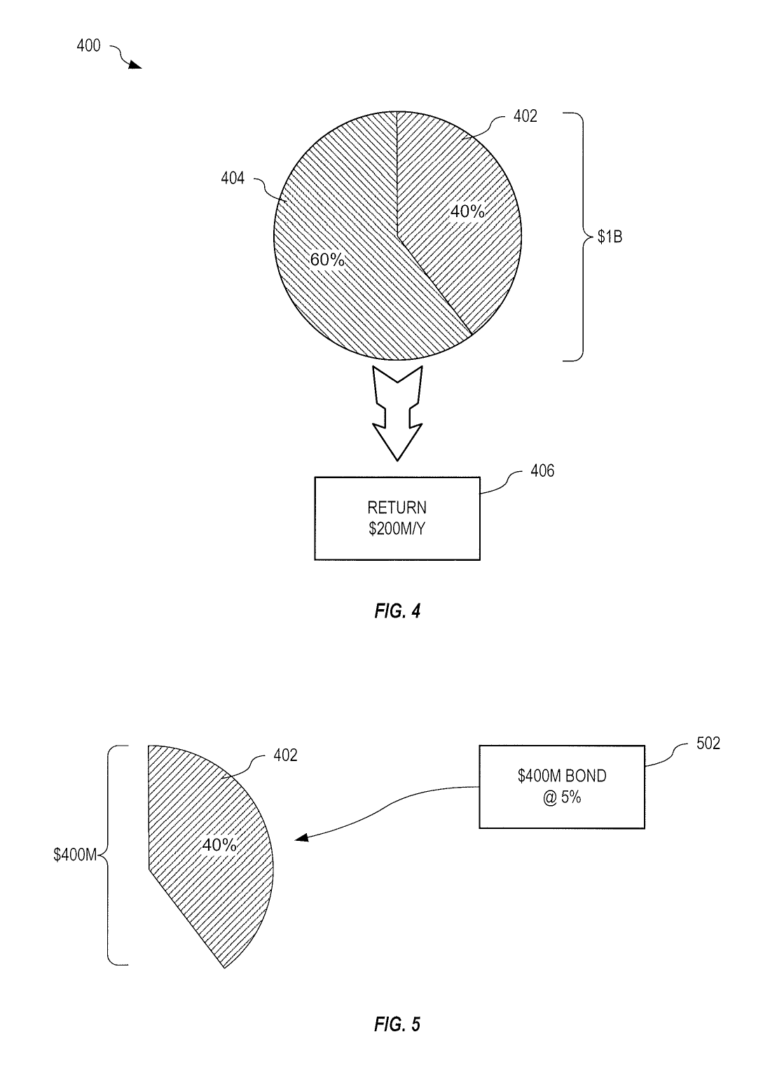

FIG. 3 shows one exemplary system 300 for leveraging capital, used for example to determine optimal parameters in leveraging venture capital to increase returns for both limited partners (LPs) (i.e., investing partners) and general partners (GPs) (i.e., managing partners) when compared to conventional methodologies. System 300 is shown with a computer 302 with memory 304, storage 306 and a processor 308. Optionally, computer 302 may connect to a printer 310 and a terminal 312.

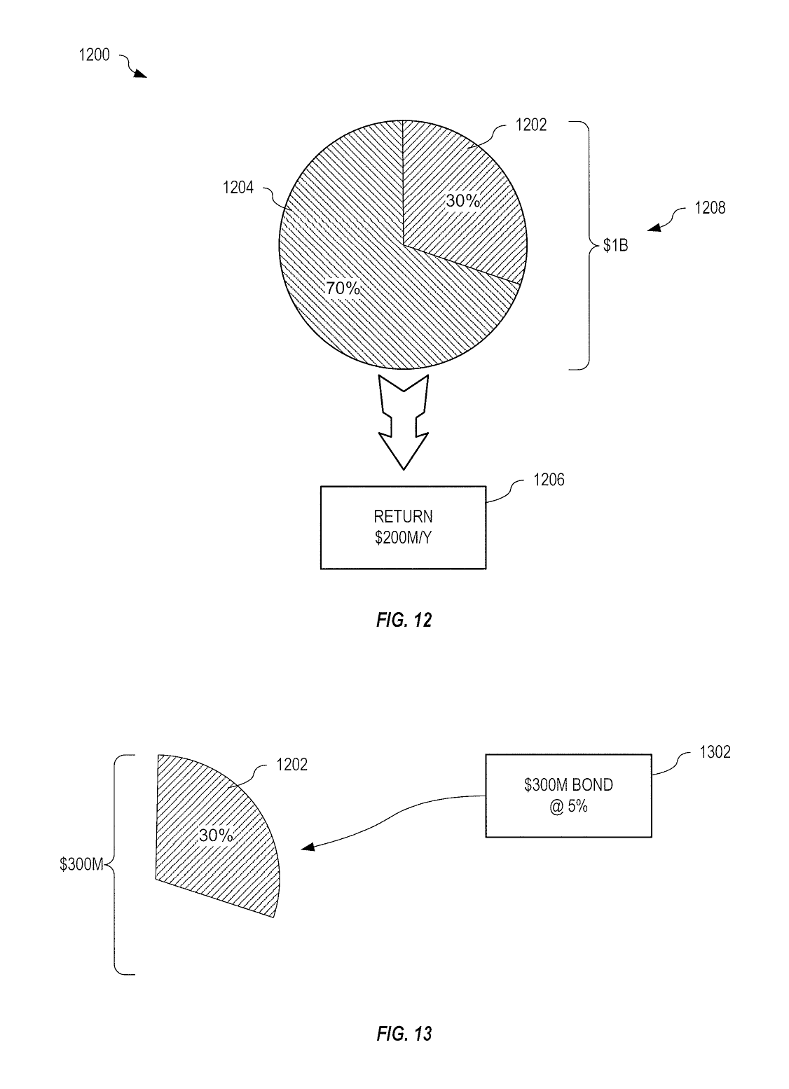

Memory 304 may be a volatile memory, such as provided by random access memory. Storage 306 may be a non-volatile storage such as provided by a disk drive. Storage 306 is shown with a simulator 320, investment guidelines 322, fund goals 324, investment scenarios 326 and investment rating data 328. Investment scenarios 326 may specify a range of economic conditions over which the fund investments are modeled. In operation, processor 308 loads simulator 320 into memory 304 (simulator 320 is shown in dashed outline within memory 304) and executes simulator 320. Simulator 320 generates a model 330 based upon input from investment guidelines 322, fund goals 324, investment scenarios 326 and investment rating data 328. Model 330 describes a fund 332 that may be formed with investment capital as shown in FIGS. 4 and 12. Model 330 and fund 332 are manipulated and evaluated by simulator 320 to achieve fund goals 324. Solutions for fund 332 that achieve fund goals 324 may be output from model 330 and stored in storage 306, as optimal pool financing structure 334 and optimal investment parameters 336.

In an example of further operation, a user of computer 302 interacts with terminal 312 to operate computer 302 and input one or more of investment guidelines 322, fund goals 324 and investment scenarios 326; computer 302 then simulates fund 332 within model 330 and generates optimal pool financing structure 334 and optimal investment parameters 336. Optionally, the user may print optimal pool financing structure 334 and optimal investment parameters 336 upon printer 310.

System 300 may be beneficially used, for example, to determine parameters of a fund that increases available capital from equity and venture pools, for example, thus making it simpler and faster for GPs to raise money for the funds. System 300 may increase the capital available for funds by reducing the risk of investment in the fund for a significant portion of the investment paper holders of the fund; further, system 300 may allow a percentage of such investment papers to achieve an investment grade rating, thereby making investment into the fund appealing to a larger audience of potential investors and to investors with more money available for investment. The process of finding investors willing to invest in a fund as an investment grade paper holder may also be faster and easier for GPs than the process for raising equity.

Within model 330, simulator 320 utilizes the allocation of future cash-flows to structure a portion of the capital raised for fund 322 in such a way that the return on that portion of capital is more secure than the return on the remainder of the capital in fund 332. That portion of the capital thus forms a certain class of security. The rate of return to this class of security may thus be set and guaranteed by the performance of the entire portfolio for which fund 332 is used. In an embodiment, system 300 creates a class of security (or even multiple classes of securities) that achieve an investment grade rating from a recognized rating agency; this may be accomplished in a number of ways, many of which may be used in parallel to further improve the creditworthiness of the intended security.

FIG. 4 shows one exemplary modeled fund 400 that includes a first class of security 402 that forms 40% of the equity of fund 400 and a remaining 60% equity that is formed from LP investment 404. Fund 400 may represent fund 332 of FIG. 3. In the example of FIG. 4, fund 400 has a total value of one billion dollars; first class security 402 therefore has a value of $400 million. Continuing the example of FIG. 4, fund 400 is shown with a return 406 of $200 million per year, based upon its investment portfolio. FIG. 5 shows first class of security 402 being structured as a single bond 502 of $400 million with an interest rate of 5%, in this example.

In addition to creating access to a broader spectrum of investors, an additional benefit of obtaining an investment grade rating for first class of security 402 may be to lower the overall cost of fund 400. By lowering the cost of capital for a portion of fund 400, a correspondingly higher return may be paid to both the LPs who own the non-rated portion of the fund, as well as the GPs, provided that the average return for fund 400, as a whole, exceeds the yield required for the investment grade securities formed by first class security 402.

Portions of a fund that are ratable as investment-grade securities (e.g., security 402) may also qualify as a publicly rated offering. These securities may have improved liquidity and a more favorable status in the portfolio of regulated investment companies such as banks, insurance companies and pension funds. The amount of capital available in the market that such a security qualifies is significantly larger than for non-qualified securities, thereby facilitating the task of raising capital for the fund. The return to those buying the non-rated securities may be higher than the returns available from non-structured funds (as long as the weighted average return for the fund as a whole exceeds the weighted average return of the rated securities).

Certain benefits of simplifying the capitalization of a fund, appealing to a broader spectrum of investors and lowering the cost of funds, may be realized by system 300 even without seeking an investment grade rating for the debt portion of fund 332. For example, providing seniority for receiving returns to one or more classes within fund 332 may, in itself, be sufficient incentive to make the investment opportunity appealing to a wider range of investors than it would be if fund 332 were not structured in such a manner. Furthermore, because of the additional security that seniority provides, the guaranteed return to such a class may, in general, be much less than the projected return for the fund as a whole. Thus, system 300 may be used for recapitalizing existing funds as well as for capitalizing new funds.

In an embodiment, system 300 introduces credit enhancement that is achieved through allocation and division of cash flows and not by guarantees from third-party sources. System 300 may calculate the percentage of the capital invested in the overall fund for which an investment grade rating may be obtained by modeling the ability of fund 332 to service its debt under various possible economic scenarios (e.g., investment scenarios 326). Actuarial data based upon historical performance of similar portfolios and historical performance data for the custodians of the fund may be included within investment scenarios 326 for input into model 330 so that a range of potential economic scenarios are covered in the sensitivity analysis of fund 332.

Security ratings essentially determine the probability of the timely repayment of scheduled payments. The probability of timely repayment is not only a function of the strength of the assets from which the cash flow for the repayments are derived, which is what the calculated seniority positions enhance, but it is also a matter of liquidity. In an embodiment, system 300 may calculate the amount of liquidity required by establishment of funded reserves, which are in turn backed by a master servicing agent. System 300 may also reduce the cost of the master servicing agent by accurately modeling potential economic scenarios.

The function of a “master servicing agent” is different from that of a “credit enhancer.” For example, servicing agents advance payments to bondholders, and have priority over the creditors in recovering their advances though liquidation of collateral assets backing the debt. On the other hand, credit enhancers make up for payments in principal and interest when they are missed and are often the last to recover their proceeds from cash flow or liquidation of collateral assets. The difference in the relative risk between the function of servicing and credit enhancement represents an important component in the difference in cost between the historical approach to credit enhancement for venture capital funding and the proposed methodology.

There are various levels of investment grade securities. System 300 may be utilized to create fund 332 with securities of multiple rating levels, each of which may be sold as an individual class of investment grade security to investors. In the financial market, each investment grade security has a corresponding yield requirement. By structuring debt issued by the venture fund into multiple levels of seniority, a further reduction in the cost of capitalizing the fund may be achieved. In general, the difference between the yield requirements for each rating level may define how many levels of seniority are optimal for a given fund.

If the projected return for the fund is higher than the yield required for the rated securities, then a computer model may be used, as described below, to determine the various synthetic investment grade bonds that may be created. The coupon rate (e.g., annual interest) for these synthetic investment grade bonds may be set to be any amount between the Weighted Average Yield (WAY) for the fund and the market yield required for the bond. By allocating a higher coupon rate than the market rate for an investment grade bond, an interest-only synthetic security may be created, the present value of which may be sold in the market to raise additional capital for the fund. Funds raised from the sale of the present value of the interest-only income stream may thus be used to reduce the amount of non-rated equity required for the capitalization of the fund.

Because of the uncertainty in the future performance of investments made by the venture fund, the projected WAY for the fund that is feasible for setting the upper limit for the coupon rate for the rated securities must be conservatively modeled based both upon historical actuarial data for the market as a whole, as well as historical actuarial data for the managing partners (GPs) of the fund itself. In certain embodiments, system 300 may model cash flow for fund 332 to determine one or more optimal levels for coupon rates of each investment grade security. If the coupon rates for the investment grade securities are set too high, additional subordination may be required, which at some point will negate the increase in the present value of an interest-only income stream.

The value of having a coupon rate higher than the market yield required by the rated security level can be realized by creating derivative (i.e., synthetic) securities from the primary bond issued by the fund. Thus, in an embodiment disclosed herein below, computer modeling creates a derivative Interest Only (“IO”) strip from the primary bond by issuing a secondary bond with a coupon rate at the market rate backed by the primary bond. The difference in yield between the primary bond and the secondary bond may then be sold as an income stream in which the Present Value (“PV”) realized from the sale of the IO strip may be added to the principal amount raised from the sale of the bonds. In order to maximize the PV of the 10, the ability of the Venture Fund to repay the primary bond prior to the date of maturity may be tied to the payment of a prepayment penalty in an amount sufficient to make the buyer of the IO whole at the time of the prepayment.

Thus the present disclosure may provide for the following non-limiting features, features that may be obtained, at least in part, by utilizing computers and software as described in the system embodiments herein. Certain variations to these features are noted in the listing of claims in this application:
1. Guidelines for investments that the venture fund intends to make are mathematically modeled such that a reasonable range for the future performance of the fund can be predicted. The financial structure for funds already invested may be recast such that the modeling of future performance involves quantitatively evaluating the existing portfolio instead of the fund's investment guidelines. A lower range for future performance of the fund may help insure minimum returns, particularly for new funds, by utilizing liquidation preferences in investments and by building in reserves for servicing the fund's debt.
2. A projected return for the fund mathematically evaluated through the computer modeling operates through a range of general economic conditions as well as fund-specific conditions, to establish the fund's performance under various worst-case scenarios and to determine what levels of subordination and reserves are necessary to insure that the fund is able to repay its investment grade debt under the projected worst-case scenarios.
3. The fund is also computer modeled for the rating agencies; their analysis of the factors involved in paragraph 2 above, along with their standard due diligence procedure, are input in the computer model to calculate the levels of subordination that are used to achieve an investment grade rating on the bonds. In the event that the fund's investment structure is being recast, this stage is correspondingly simpler to model because many of the unknowns regarding the nature of the portfolio have been removed.
4. Once indicated ratings have been calculated, the fund may register its investment grade securities through the SEC for sale through an investment banker, reducing the amount of capital that it needs to raise through the sale of equity units. This reduces the time and effort that fund managers spend on raising capital while also reducing the average cost of funds for their investment vehicle.

The degree that the issuance of investment grade bonds may be used to increase the ROI of the equity portion of the fund may be calculated by way of the following example:

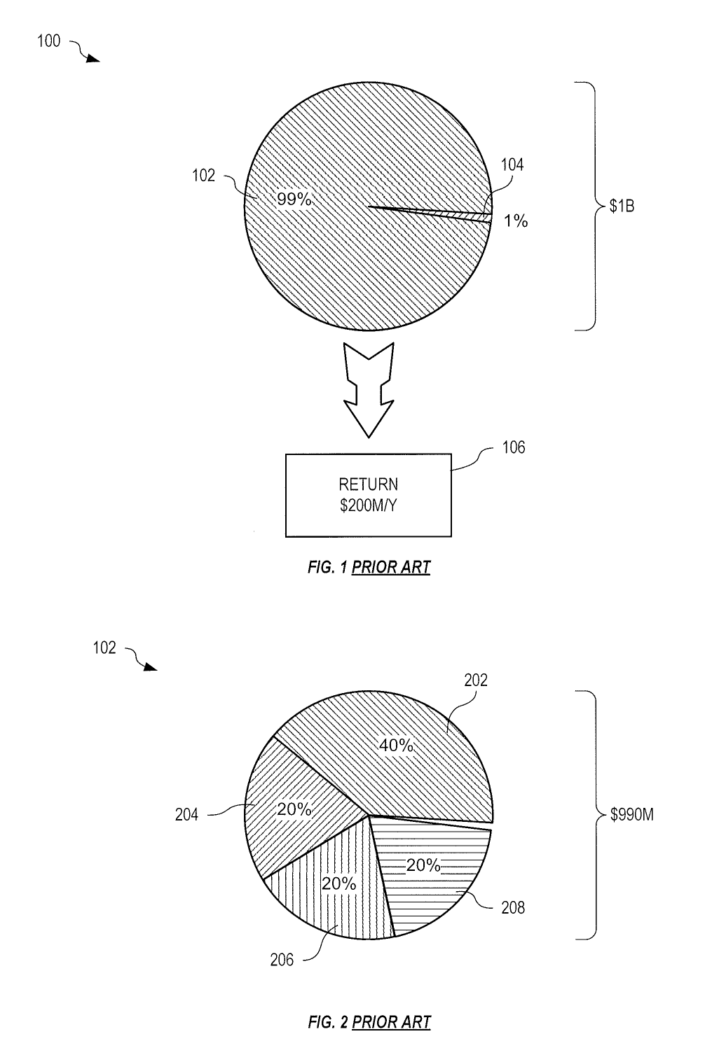

Using the example of FIG. 4, fund 400 is capitalized with $1 billion. If fund 400 produces an average annual yield of 20%, then structuring $400 million of fund 400 as debt requiring a 5% interest-only annual payment costs fund 400 $20 million per year in debt service. Since fund 400 returns $200 million per year, after paying the $20 million per year interest on the interest-only loan, fund 400 returns $180 million per year for the $600 million in equity invested by LPs. The effective yield for these LPs is therefore 30% (as compared to 20% if the entire $1 B fund was financed by LP investors in FIG. 1). The effective level of security provided to the bond-holder in this example is a debt service coverage ratio of 10:1 (debt service coverage ratio being defined by: earnings before interest and income taxes, divided by interest expense plus quantity of principal repayments divided by one minus the tax rate)

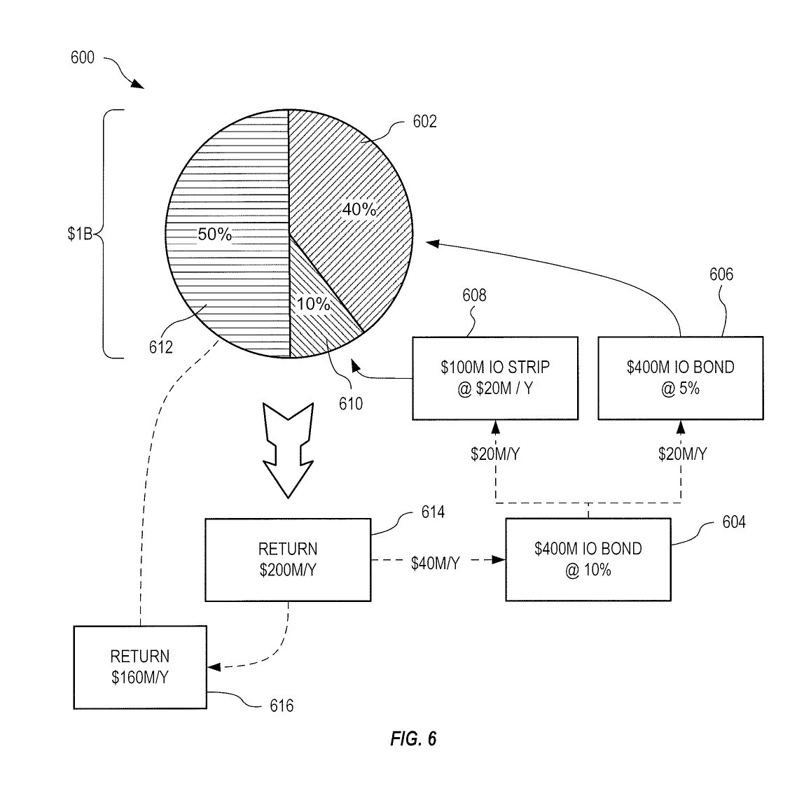

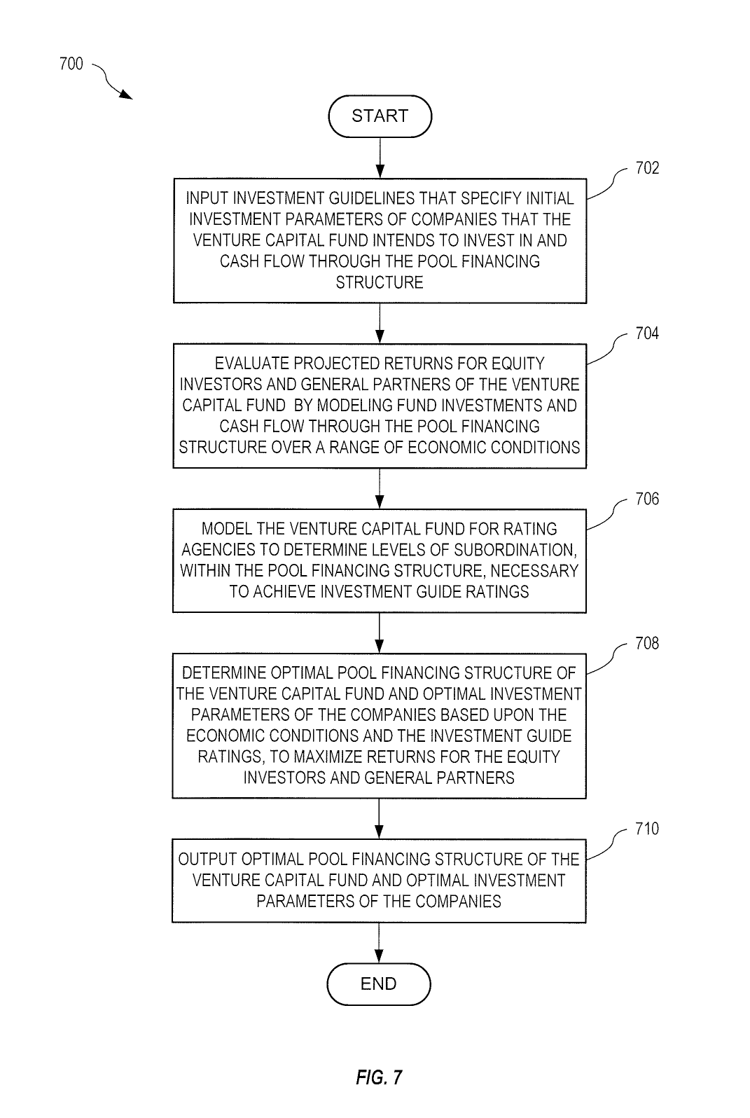

FIG. 6 illustratively shows one exemplary $1 billion fund 600 that may be determined and modeled as fund 332 by system 300, FIG. 3. For fund 600, it is determined that fund 600 may generate 40% of its equity 602 from an interest-only primary bond 604 of $400 million with a coupon value of 10%. Bond 604 thus costs $40M per year. Where the coupon rate (i.e., 10%) of bond 604 is greater than the average market coupon rate, a secondary bond 606 may be issued for $400M with an average market rate coupon value of 5%, thus costing $20M per year. Since the primary bond is earning $40M per year, there is $20M per year remaining. Thus, in this example, an IO strip 608 is issued for the remaining $20M per year with a present value (PV) of $100M, thereby adding 10% equity 610 to fund 600. Thus, only 50% equity 612 of fund 600 need be raised from LPs.

In summary, the yield from primary bond 604 that yields 10% ($40M per year) is paid into a pool that pays (a) secondary bond 606 yielding 5% ($20M per year) and (b) IO Strip bond 608 for $20M per year. Secondary bond 606 is sold for face value, generating $400 million for equity 602, and the rights to the income stream ($20M per year) for 10 strip bond 608 is sold to generate $100M for equity 610. Thus, the amount of equity necessary (i.e., LP equity 610) to fully capitalize fund 600 is reduced from $600M (as shown in the example of fund 400, FIG. 4, to $500M.

In this example, the annual return 614 on fund 600 is $200 million. Therefore, after paying $40M per year as cost of primary bond 604 (i.e., the debt service on $400M), $160M per year is available as a return 616 on the $500M of equity 612, representing an annual return to the LPs of 32%.

In order to ensure that the buyer of IO strip bond 608 does not lose the principal investment in the event of a prepayment of primary bond 604, a declining prepayment penalty may be determined (e.g., by system 300), to be required of primary bond 604. In the example of FIG. 6, the penalty may be calculated to be about $100 million for a prepayment of primary bond 604 on day one, declining to zero dollars on the final day of maturity of the IO strip bond 608 (i.e., after 10 years in this example).

The key challenge in securitizing equity funds and/or venture capital occurs with the uncertainty in projecting returns for the fund. However, there is a substantial body of actuarial data relating to venture capital investment that covers a wide range of economic cycles; this data may, for example, be built into model 330, FIG. 3, and/or input as investment scenarios 326, for calculating the requisite subordination levels. In addition, timing the returns on venture investments in a way that will better meet the strict schedule of payments due investment grade securities can be accomplished through either the use of a) funded reserves, and/or b) accrued interest bonds (e.g., zero coupon bonds). Because the return of an investment fund is proportional to the percentage of fund capital invested in portfolio properties versus the percentage of the fund held in reserve, repayment schedules that defer payments until after the portfolio properties have had sufficient time to produce a return may be preferential over schedules requiring interest payments early in the life of the fund.

### Modeling Performance of Venture Funds

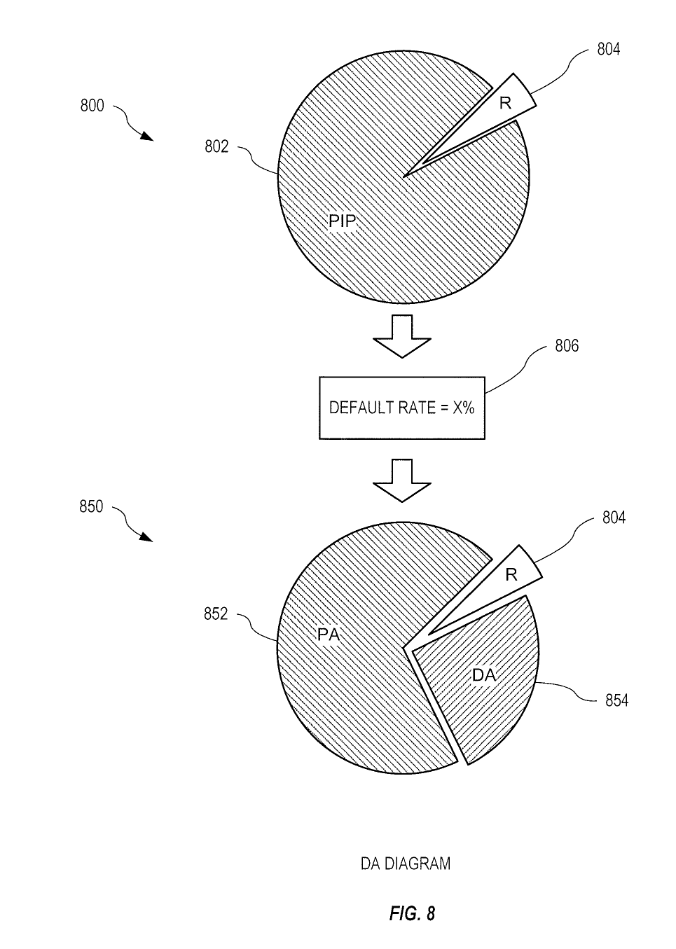

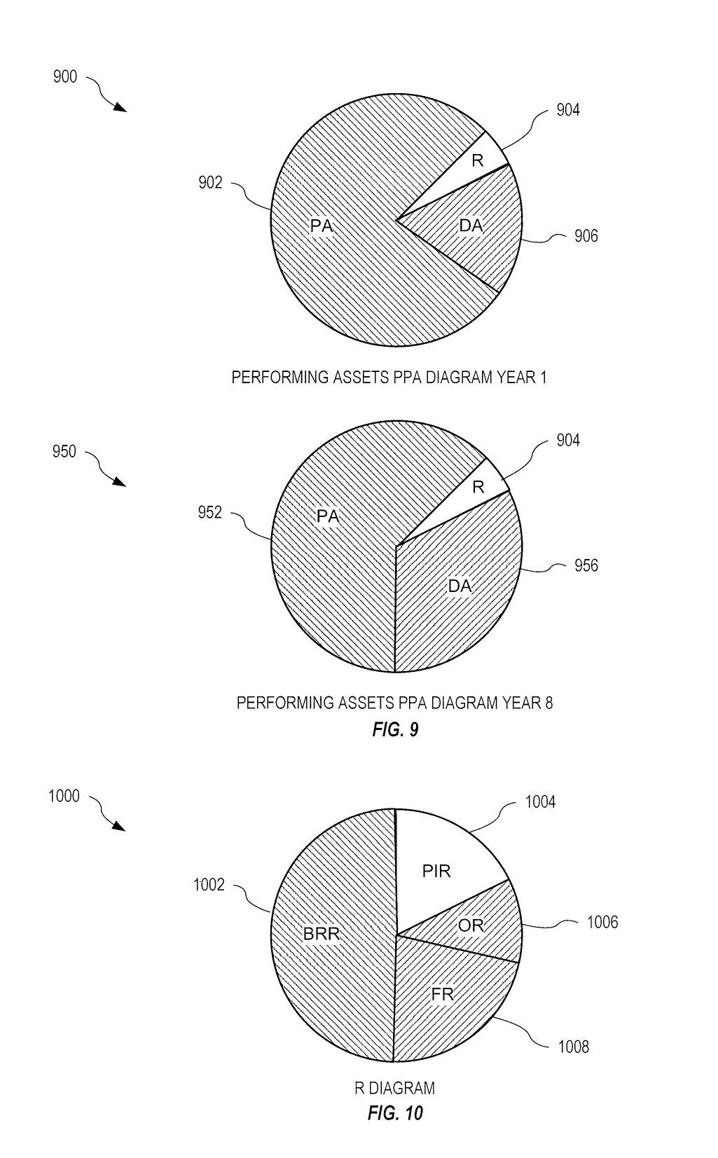

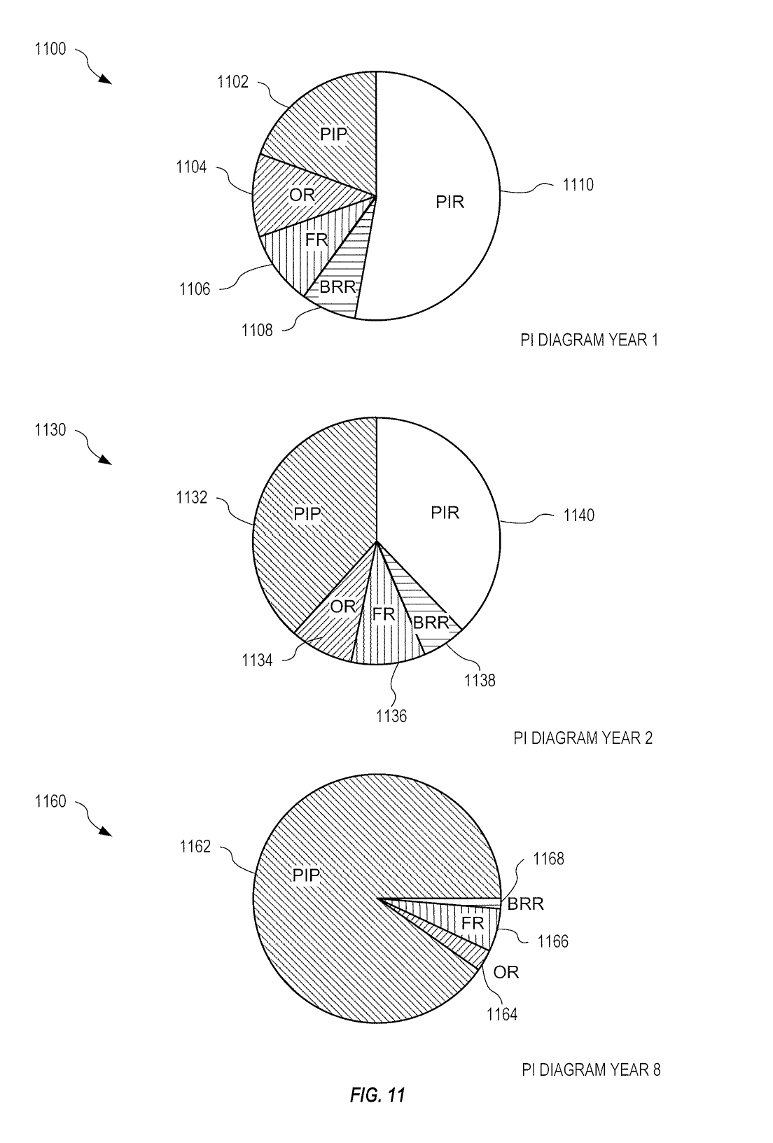

FIGS. 8, 9, 10 and 11 are best viewed together with the following description. FIG. 8 shows principal 802 (e.g., as modeled by fund 332) intended to be invested in the portfolio that becomes defaulted between year one 800 and year eight 850, and a portion 804 set aside as reserve. Principal 802 is referred to herein below as Principal Invested in the Portfolio (“PIP”) 802, and portion 804 is referred to herein below as total Reserve (“R”) 804. FIG. 9 shows expected increase in the ratio of defaulted assets to principal invested between year one 900 and year eight 950; FIG. 10 shows a reserve portion (total reserve) 1000 of the fund (e.g., as modeled by fund 332) broken into component parts and described in detail below; and FIG. 11 shows expected changes to components of year one total Reserve 1100, year two total Reserve 1130 and year eight total Reserve 1160.

Not all fund money intended for investment in early stage companies and equities is immediately invested. For example, assets are identified and evaluated and the relative position of the investment in the company or equity is negotiated. Therefore, a fund may have a Pre-Invested Reserve (PIR) 1004, 1110, 1140 that shrinks as the fund becomes invested. The fund may also operate with an Overhead Reserve (OR) 1006, 1104, 1134, 1164 for overhead associated with the administration and management of the fund. Because the amount of money that an early stage company, or other equity for that matter, may require in order to fully realize its financial potential may be hard to determine in advance, it may be prudent to also operate the fund with a Follow-up Reserve (FR) 1008, 1106, 1136, 1166. For example, if the debt portion of the fund is obligated to make payments prior to realization of sufficient return from the fund's portfolio, then it may also be necessary to establish a Bond Repayment Reserve (BRR) 1002, 1108, 1138, 1168 that is funded from the initial capital raised for the fund.

The total Reserve (R) 804, 904, 1000, 1100, 1130, 1160, required for the fund is equal to the sum of all necessary reserves. Therefore, when modeling the fund to determine the potential return on the fund and what percentage of the fund may be deemed to be investment grade debt, the total Reserve may be calculated as shown in Equation 1.

R=PIR+OR+FR+BRR Equation 1—Reserve

The Principal Invested in the Portfolio (PIP) 802, 1102, 1132, 1162, at any given point in time is also a function that may be modeled on a computer as the Capital Raised (CR) less Reserves, as shown in Equation 2.

PIP=CR−R Equation 2—Capital Raised (Simplified)

The PIP may be divided into Performing Assets (PA) 852, 902, 952 and Defaulted Assets (DA) 854, 906, 956, which can be determined by Equation 3 and which are shown in FIGS. 8 and 9, respectively.

PA=PIP−DA Equation 3—Performing Assets

The DA 854 may be determined as PIP 802 times the Default Rate (DR) 806, as shown in Equation 4 and FIG. 8.

DA=PIP×DR Equation 4—Defaulted Assets

The DR 806 may be projected for any time interval necessary in modeling the performance of the fund, including annually or over the life of the fund as shown in FIG. 9. However, the DR 806 alone is not sufficient to calculate actual losses in principal for the fund, but must be modeled as a function of Recovery Value (RV), Exposure Value (EV) and the Cost of Recovery (COR). The loss on DA is a function of EV divided by RV less COR.

EV is similar to the loan as is value of a loan in real estate lending to the value of the asset against which the loan is made. In venture capital this is often a function of liquidated preferences and percentage of ownership in a company versus the liquidation value of the company. RV is the liquidated value of the company, and COR is the total cost associated with liquidating the company.

Thus, PA may be modeled as Equation 5.

PA=PIP−(PIP×DR(EV/(RV−COR)) Equation 5—Modeling Performing Assets

To be conservative, EV/(RV−COR) may be simplified as “one” in terms of its numerical value, and therefore PA again equals PIP−DR as shown in Equation 3.

By modeling the above equations, a Return On Investment (ROI) for the Capital Raised (CR) may be determined. In a simplified form, this may be modeled as shown in Equation 6.

CR_{ROI}=PIP_{ROI}(PIP/CR) Equation 6—ROI for Capital Raised (Simplified)

where CR_{ROI} is the Return On Investment on the Capital Raised, and PIP_{ROI} is the Return On Investment of the Principal Invested in the fund's Portfolio.

This may be more fully modeled as shown in Equation 7.

CR_{ROI}=(PIP−(PIP×DR(EV/(RV−COR)))ROI(PIP/CR) Equation 7—ROI for Capital Raised (Detailed)

Expanding on PIP, this may be modeled as shown in Equation 8.

CR_{ROI}=CR−PIR−OR−FR−BRR−((CR−PIR−FR−BRR)(EV/(RV−COR)))ROI(PIP/CR) Equation 8—PIP (Detailed)

Modeling the above allows one to model the Return On Investment on the Equity Raised (EQ_{ROI}) as shown in Equation 9.

EQ_{ROI}=(CR_{ROI}−COD)(CR/PEQ) Equation 9—ROI on Equity Raised

where COD is the Cost Of Debt expressed in terms of a percentage, and PEQ is Principal amount of Equity in the pool as opposed to debt in the pool.

This allows the increase in the return to the equity class to be modeled when debt is included in the fund.

When multiple classes of debt are included in the fund, they may each have their own COD, which are expressed hereinafter as COD1, COD2, and so on. Therefore the effect of multiple classes of debt upon the return to the equity class may be modeled as shown in Equation 10.

EQ_{ROI}=(CR_{ROI}−COD1(D1/CR)−COD2(D2/CR) . . . −CODn(Dn/CR))(CR/(CR−D1−D2 . . . −Dn)) Equation 10—EQ_{ROI} for Multiple Classes of Debt

where D1, D2 and Dn are the principal amounts of each class of debt.

In one example where D1 and D2 represent two classes of debt in a fund, if CR_{ROI} is 20%, COD1 is 10%, D1 represents $50 Million, CR is $100 Million, COD2 is 12%, D2 represents $25 Million, then Equation 10 may be used to determine EQ_{ROI} as follows:

EQ_{ROI}=(0.2-0.1(50,000,0001100,000,000)−0.12(25,000,000/100,000,000))×(100,000,000/(100,000,000-50,000,000-25,000,000))

which gives:

EQ_{ROI}=(0.2−0.1(0.5)0.12(0.25))×(100/(100−50−25))

which is:

EQ_{ROI}=(0.2−0.05−0.03)×4=48%

Therefore the effect of debt classes in this example takes a return of 20% on the total capital raised and creates a return of 48% on the equity raised.

The foregoing also applies to other equity situations where instead of funds we are talking about debt instruments.

FIG. 7 is a flowchart illustrating one exemplary method 700 for leveraging capital, e.g., to leverage a venture capital fund. In step 702, method 700 inputs investment guidelines that specify initial investment parameters of companies that the venture capital fund intends to invest in and cash flow through the pool financing structure. In one example of step 702, simulator 320 inputs investment guidelines 322 into model 330. In step 704, method 700 evaluates projected returns for equity investors and general partners of the venture capital fund by modeling fund investments and cash flow through the pool financing structure over a range of economic conditions. In one example of step 704, simulator 320 inputs investment scenarios 326 into model 330 and simulates fund 332 over a range of economic conditions. In step 706, method 700 models the venture capital fund for rating agencies to determine levels of subordination, within the pool financing structure, necessary to achieve investment guide ratings. In one example of step 706, simulator 320 inputs investment rating data 328 that includes actuarial market investment data into model 330 to determine levels of subordination necessary to achieve investment guide ratings for fund 332. In step 708, method 700 determines optimal pool financing structure of the venture capital fund and optimal investment parameters of the companies based upon the economic conditions and the investment guide ratings, to maximize returns for the equity investors and general partners. In one example of step 708, simulator 320 evaluates fund 332 to determine optimal fund parameters (e.g., optimal pool financing structure 334 and optimal investment parameters 336) based upon modeled economic conditions and investment guide ratings. Steps 704 and 706 may repeat during step 708 to determine optimal pool financial structure and optimal investment parameters. In step 710, method 700 outputs optimal pool financing structure of the venture capital fund and optimal investment parameters of the companies. In one example of step 710, simulator 320 outputs optimal pool financing structure 334 and optimal investment parameters 336 from model 330 to storage 306.

### Obtaining Financing Against Capital Commitment

The equity pledged by investors in a VC pool is typically pledged in the form of capital commitments. Normally only a certain percentage of the total capital commitment is actually called upon (typically around 70%) for fund equity. FIG. 12 shows one exemplary modeled fund 1200 (i.e., a VC pool) that has a capital commitment 1208 of $1 B. Fund 1200 may represent fund 332 of FIG. 3. A capital call results in 70% equity 1204 of fund 1200, and a first class of security 1202 forms the remaining 30% equity of fund 1200. In the example of FIG. 12, fund 1200 has a total value of one billion dollars. A capital call results in $700 million of invested equity from investors and a first class security 1202 provides the remaining $300 million equity. In the example of FIG. 12, fund 1200 is shown with a return 1206 of $200 million per year, based upon its investment portfolio. FIG. 13 shows first class of security 1202 being structured as a single bond 1302 of $300 million with an interest rate of 5%, in this example.

The actual ROI for each investor in the VC pool is based upon the amount of capital actually called upon from the investor and invested in the VC pool, and the total liability incurred by the investor in signing a capital commitment. The treatment of this liability depends in some measure upon the nature of the investing institution; regulatory requirements may require certain capital reserves and set asides for the capital commitment, and the ability to fulfill the capital call will impact the nature of the assets that can be invested in, since such assets must be liquid enough (i.e., to allow prompt sale) in order to fulfill any capital call.

The credit worthiness of each investor in the VC pool is relied upon in terms of their ability to fulfill the capital call, based upon their capital commitment, to fund the VC pool. Rather than calling upon their equity investors for capital, however, the VC pool may obtain financing against the capital commitment obligations of their investors. The ability to issue rated securities against the VC pool's capital call obligations may depend upon a combination of factors, shown in.

TABLE 1
Security Issue Related Factors

The credit worthiness of each investor and/or security pledged by the
investor to guarantee their capital commitment.
The terms and conditions of the capital commitment, especially with
regard to its enforceability under all probable future scenarios.
The percentage of the capital commitment being borrowed against in
terms of principal amount of the bonds and their associated schedule of
interest payments due.
The pool's investment guidelines, not only in terms of the nature of the
portfolio, but in terms of the percentage of the total call amount
available that will be invested in the portfolio versus held for future
debt service.
The controls in place to insure compliance with the terms and
conditions referenced above (e.g., the use of trustees and servicing
agents).

These factors may be input to system 300, FIG. 3, to allow fund 1200 (FIG. 12) to be modeled (i.e., as fund 332 within model 330) to determine optimum financial structuring for fund 1200.

The net effect of financing the VC pool using issue rated securities collateralized against capital commitments to the VC pool, is to extend the leveraging effect of financing the pool; the investors achieve a higher cash-on-cash return against the dollar amount called upon if the pool employs financing compared to return achieved if the pool calls upon its capital commitments, provided that the VC pool's portfolio generates a return in excess of the cost of the issue rated securities. Continuing with the example of FIGS. 12 and 13, bond 1302 may incur a debt of $15M per year, leaving a return for investors of $185M per year, based upon return 1206 of $200M per year. Thus, for the $700M equity investment (i.e., 70% equity called upon from investors for modeled fund 1200), a return of over 26.4% is achieved as compared to a 20% return for investors when fund receives a 100% capital call.

Financing a VC pool against capital commitment is, in most circumstances, more straight forward than financing the VC pool against the variable value of its investment portfolio, especially since the value of the portfolio can only be established over time once the initial investment has been made.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for determining pool financing structure of a venture capital fund, comprising:
inputting investment guidelines that specify initial investment parameters of companies that the venture capital fund intends to invest in and cash flow through the pool financing structure;
evaluating projected returns for equity investors and general partners of the venture capital fund by modeling fund investments and cash flow through the pool financing structure over a range of economic conditions;
modeling the venture capital fund for rating agencies to determine levels of subordination, within the pool financing structure, necessary to achieve investment guide ratings; and
determining optimal pool financing structure of the venture capital fund and optimal investment parameters of the companies based upon the economic conditions and the investment guide ratings, to maximize returns for the equity investors and general partners.

2. The method of claim 1, wherein inputting comprises inputting investment guidelines that specify an initial structure of investments in each of the companies.

3. The method of claim 1, wherein the method is employed in connection with raising initial capital for the venture capital fund.

4. The method of claim 1, wherein the method is employed in connection with restructuring an existing venture capital fund.

5. A method for determining pool financing structure of a venture capital fund, comprising:
inputting investment guidelines that specify initial investment parameters of companies that the venture capital fund intends to invest in and cash flow through the pool financing structure;
inputting capital commitment information of investors in the venture capital fund;
evaluating projected returns for the investors by modeling fund investments and cash flow through the pool financing structure over a range of economic conditions;
modeling the venture capital fund for the capital commitment, capital call and issue rated securities to determine optimal pool financing structure of the venture capital fund and optimal investment parameters of the companies based upon the economic conditions and the issue rated securities, to maximize returns for the investors.

6. The method of claim 5, wherein inputting comprises inputting investment guidelines that specify an initial structure of investments in each of the companies.

7. The method of claim 5, wherein the method is employed in connection with raising initial capital for the venture capital fund.

8. The method of claim 5, wherein the method is employed in connection with restructuring an existing venture capital fund.

9. A software product comprising instructions, stored on computer-readable media, wherein the instructions, when executed by a computer, perform steps for determining parameters of a venture fund, comprising:
instructions for inputting investment guidelines that specify initial investment parameters of companies that the venture capital fund intends to invest in and cash flow through the pool financing structure;
instructions for evaluating projected returns for equity investors and general partners of the venture capital fund by modeling fund investments and cash flow through the pool financing structure over a range of economic conditions;
instructions for modeling the venture capital fund for rating agencies to determine levels of subordination, within the pool financing structure, necessary to achieve investment guide ratings; and
instructions for determining optimal pool financing structure of the venture capital fund and optimal investment parameters of the companies based upon the economic conditions and the investment guide ratings, to maximize returns for the equity investors and general partners.

10. The software product of claim 9, wherein the instructions for inputting comprise instructions for inputting investment guidelines that specify an initial structure of investments in each of the companies.

11. The software product of claim 9, wherein the software product is employed in connection with raising initial capital for the venture capital fund.

12. The software product of claim 9, wherein the software product is employed in connection with restructuring an existing venture capital fund.

13. A software product comprising instructions, stored on computer-readable media, wherein the instructions, when executed by a computer, perform steps for determining pool financing structure of a venture capital fund, comprising:
instructions for inputting investment guidelines that specify initial investment parameters of companies that the venture capital fund intends to invest in and cash flow through the pool financing structure;
instructions for inputting capital commitment information of investors in the venture capital fund;
instructions for evaluating projected returns for the investors by modeling fund investments and cash flow through the pool financing structure over a range of economic conditions;
instructions for modeling the venture capital fund for capital commitment, capital call and issue rated securities to determine optimal pool financing structure of the venture capital fund and optimal investment parameters of the companies based upon the economic conditions and the issue rated securities, to maximize returns for the investors.

14. The software product of claim 13, wherein the instructions for inputting comprises instructions for inputting investment guidelines that specify an initial structure of investments in each of the companies.

15. The software product of claim 13, wherein the software product is employed in connection with raising initial capital for the venture capital fund.

16. The software product of claim 13, wherein the software product is employed in connection with restructuring an existing venture capital fund.

17. A system for leveraging capital of a venture capital fund, comprising:
memory for storing investment guidelines, fund goals, investment scenarios, and investment rating data;
a simulator for generating a model of a pool financing structure based upon the investment guidelines, fund goals, investment scenarios and investment rating data; and
a processor for executing the simulator to evaluate the performance of the pool financing structure and to determine optimal pool financing structure of the venture capital fund and optimal investment parameters of the companies, to maximize returns for investors in the venture capital fund.

18. The system of claim 17, the memory storing information of capital commitment by the investors, and the simulator generating the model to include one or more issue rated securities issued against the capital commitment.
